(19) United States
(12) Patent Application Publication
(10) Pub. No.: US 2004/0064660 A1
(43) Pub. Date: Apr. 1, 2004

(54) Multiplexed bus with multiple timing signals

(76) Inventor: Michael Stewart Lyons, San Jose, CA (US)

Correspondence Address: MORRISON & FOERSTER LLP, 755 PAGE MILL RD, PALO ALTO, CA, 94304-1018, US

(21) Appl. No.: 10/349,889

(22) Filed: Jan. 22, 2003

Related U.S. Application Data
(60) Provisional application No. 60/414,500, filed on Sep. 27, 2002.

(51) Int. Cl. G06F 12/00

(52) U.S. Cl. 711/167; 711/105

(57) ABSTRACT

Embodiments of present invention may provide a method, systems and/or computer program products for data storage utilizing multiple arrays of memories. Multiple read clocks may be generated to reflect the multiple signal path lengths of the signals to or from the multiple arrays of memories. The memory arrays may operate synchronously and may terminate and reinstate data transfer bursts without intermediate re-addressing, refreshing or restarting.

### RELATED APPLICATION

This application claims priority to provisional application entitled “METHOD AND APPARATUS FOR INFORMATION STORAGE”, filed Sep. 27, 2002, by inventors George B. Tuma, Michael S. Lyons and Hayden Metz and having attorney docket number M-12884 V1 US.

### FIELD OF THE INVENTION

This invention generally relates to information storage. The invention more specifically relates to interfaces for large arrays of semiconductors such as those useful for disk caching, and so-called “solid state disk memories”.

### BACKGROUND OF THE INVENTION

Storage area networks with communicating devices intended primarily to provide non-volatile memory are commonplace. Devices include rotating disks, with or without semiconductor caches. Other devices are non-volatile, battery-backed semiconductor memories, optionally with magnetic storage backup such as rotating disk or magnetic tape.

In order to provide higher performance storage devices than those of previously developed solutions, extremely large arrays of semiconductor memories have been used in communicating storage devices on storage area networks. Protocols and access techniques available at the storage semiconductors themselves are not well adapted to the requirements of storage area network communications. Consequently, intelligent controller circuits are provided to supervise activities such as buffering, caching, error detection and correction, sequencing, self-testing/diagnostics, performance monitoring and reporting. In the pursuit of performance such controllers preferably provide very fast data rates and very low latency time. The highest performing controllers are of complex design incorporating more than one computer architecture resulting in the need to pass data between multiple digital electronic subsystems. Necessary synchronizing of disparate digital electronic subsystems has resulted in increased repropagation, complexity or timing margins (and sometimes all of these) limiting the overall performance (speed, error rates, reliability etc.) available within price constraints.

The subject invention provides a superior tradeoff between cost, performance, complexity and flexibility for inter-subsystem interfacing within digital storage devices. The invention may also have wider application to other types of computer communication interfaces and/or networks.

### SUMMARY

The aspects of embodiments of the invention provide for non-volatile memory storage. A number of novel techniques are deployed in embodiments of the invention to provide for superior tradeoffs in performance, including but not limited to, cost, throughput, latency, capacity, reliability, usability, ease of deployment, performance monitoring, correctness validation, data integrity and so on.

According to an aspect of an embodiment of the invention, a method, system and apparatus is provided to drive arrays of RAM (Random-Access Memory), and especially SDRAM (Synchronous Dynamic RAM) with overrun/underrun pacing, superior throughput and reduced latency.

According to another aspect of an embodiment of the invention, a point to multipoint clock arrangement is used to provide superior memory timing margins at low costs and with great reliability.

Other aspects of the invention are possible; some are described below.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram of a solid state file cache such as may be used to implement aspects of an embodiment of the present invention.

FIG. 2 shows, in block diagram form, an exemplary EFC (Embedded Fibre Controller) FPGA (Field-programmable gate array) and some external connections thereto according to an embodiment of the invention.

FIG. 3 shows an SDRAM array card connected to a backplane I-O bus in block diagram form.

FIG. 4 depicts an I-O (Input and/or Output) bus backplane with connections to a controller card and multiple RAM array cards in block diagram form according to an embodiment of the invention.

FIG. 5 is a timing diagram that shows timings associated with Write transfer flow control.

FIG. 6 is a timing diagram that shows timings associated with Read transfer flow control.

FIG. 7 shows a state machine diagram for a FSM (Finite State Machine) embodied within an FPGA on an SDRAM array card according to an embodiment of the invention.

For convenience in description, identical components have been given the same reference numbers in the various drawings.

### DETAILED DESCRIPTION OF THE PREFERRED EMBODIMENTS

In the following description, for purposes of clarity and conciseness of the description, not all of the numerous components shown in the schematics and/or drawings are described. The numerous components are shown in the drawings to provide a person of ordinary skill in the art a thorough, enabling disclosure of the present invention. The operation of many of the components would be understood and apparent to one skilled in the art.

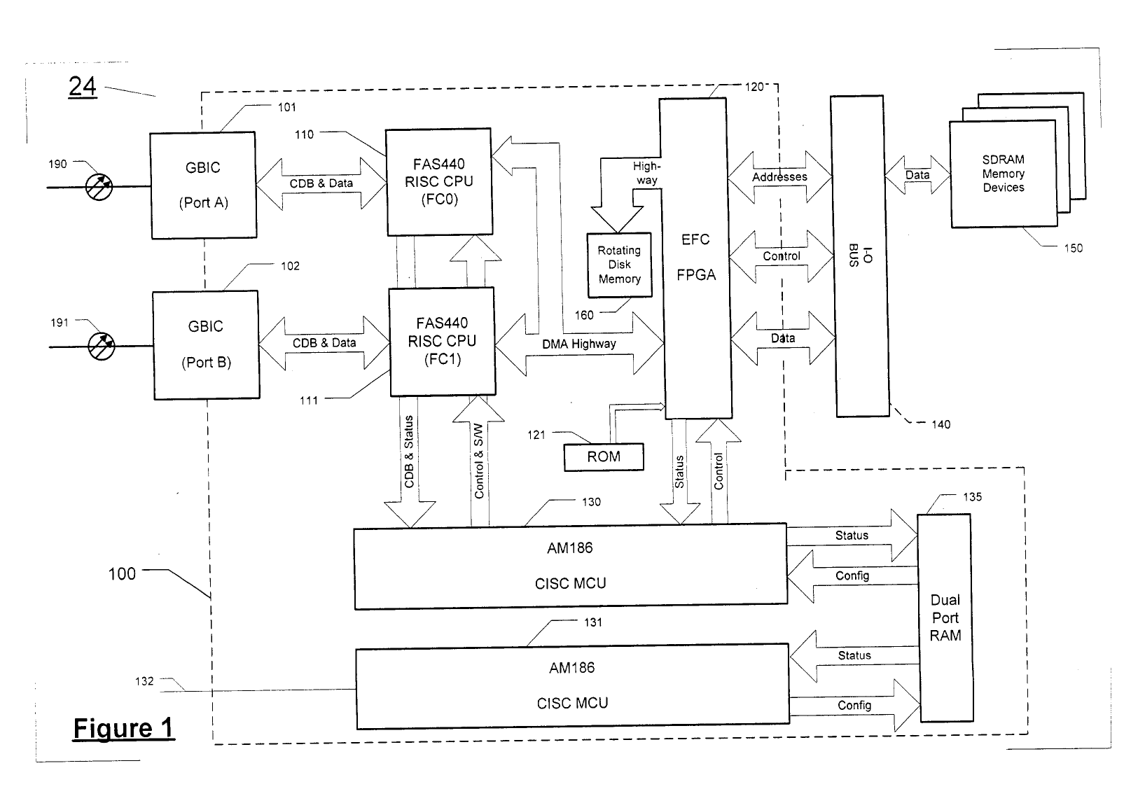

FIG. 1 is a block diagram of a solid state file cache 24 such as may be used to implement aspects of an embodiment of the present invention.

As shown in FIG. 1, a solid state file cache 24 may include a data controller 100 having one or more GBIC (Gigabit Interface Converter) circuits 101, 102 for communication using optical fiber links 190, 191 in compliance with a communication standard and protocol, for example, FCA. (Fibre-Channel architecture) The various broad arrows in FIG. 1 represent data highways that may be implemented as multi-wire ports, interconnects and/or busses. The arrowheads indicate the direction of information flow along the data highways. As indicated, these data highways may carry Data, CDB (Command Descriptor Blocks), status information, control information, addresses and/or S/W (software images).

The data controller 100 may communicate with a backplane I-O (input-output) bus 140 to read and/or write data onto an array of one or more semiconductor memories such as SDRAMs (Synchronous Dynamic Random-Access Memories) 150. The SDRAMs 150 may typically be energized by batteries (electrochemical cells, not shown in FIG. 1) so as to provide non-volatile memory storage up to the life of the batteries.

Still referring to FIG. 1, data controller 100 may include one or more FCC ICs (Fibre-Channel controller integrated circuits) 110, 111 such as the FibreFAS440™ device from Qlogic® Corp. Exemplary FibreFAS440 devices include a RISC (reduced instruction set computer) CPU (computer processing unit). As is well known, RISC CPUs are well adapted to data-oriented computing tasks of relative simplicity, but requiring very high speed. In the data controller 100, the program instructions, sometimes called microcode, may be downloaded from a CISC MCU (complex instruction set microcontroller unit) 130 such as the AM186 device from Applied Micro Devices® Inc.

As contrasted with RISC devices, CISC devices are slower, have a richer instruction set and support much larger memory address spaces of a more complex nature. They are well suited for use in implementing complex tasks that do not require the great achievable speed. The solid state file cache 24 may include a second CISC MPU 131 which may communicate with the first CISC MPU 130 via a dual ported RAM (random-access memory) 135. CISC MPU 131 may provide for RCM and/or RMR (remote configuration management and/or remote monitoring and status reporting) and the like via an optional external interface 132 such as may be implemented using Ethernet, USB (universal serial bus) or EIA-232 (an Electronic Industry Association standard).

Still referring to FIG. 1, data controller 100 may further include a FPGA (field-programmable gate array) 120 used as an EFC (Embedded Fibre Controller). A primary purpose of the EFC FPGA 120 is for moving data in a controlled and expeditious manner between FCC ICs 110, 111 and backplane I-O bus 140. As depicted, exemplary controller EFC FPGA 120 may be associated with a ROM (read-only memory) 121 to direct its operation.

As further depicted in FIG. 1, FCC ICs 110, 111 may exchange data via a DMA (Direct Memory Access) Highway with EFC FPGA 120.

A rotating disk memory 160 may typically be provided and comprise a HD (hard disk) and disk controller such as may be responsive to SCSI (small computer system interface) commands. The rotating disk memory 160 may be used to provide long term memory backup for indefinitely long periods, such as in the event of exhaustion or failure of the batteries.

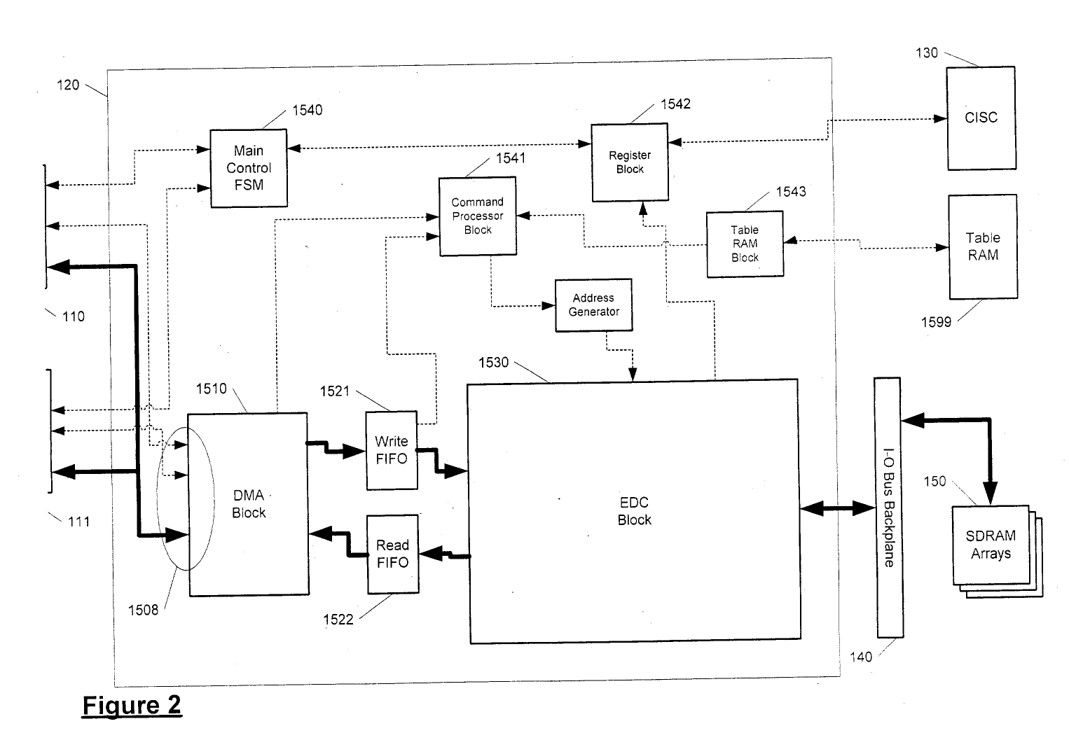

FIG. 2 shows, in block diagram form, an exemplary EFC FPGA 120 (Embedded Fibre Controller Field-programmable gate array) and some external connections thereto. EFC FPGA 120 is optimized to provide high speed, high throughput data transfer between FCC ICs 110, 111 and SDRAM memory devices 150. In FIG. 2 solid connecting lines generally indicate data flows in the directions indicated by arrowheads. Dashed lines generally indicate the flow of control information such as addresses, status lines or formatted command blocks. Shown within the EFC FPGA 120 are the DMA (Direct Memory Access) Interface 1508 and DMA block 1510, the two internal FIFOs (First-In/First-Out queues) 1521, 1522, and the EDC (Error Detection and Correction) block 1530. In the write direction, the data may come in via the DMA interface 1508, go through the Write FIFO 1521, then through the EDC block 1530, and then out to the RAM array cards 150. The read direction is similar in that data may go through the Read FIFO 1522. Towards the top of FIG. 2 is the main control block FSM 1540 (a hardware finite state machine). There is also the command processor block 1541, which performs data extraction from the FIU (Fibre-channel architecture information unit). Command processor block 1541 may be implemented as at least one FSM, buffers, registers etc. Register block 1542 is shown, which interfaces to CISC (complex instruction set computer) processor 130. Table RAM block 1543 may be interfaced to an internal or external Table RAM 1599 where stored may be all the address and LUN (Logical Unit Number) information.

A functional description of the EFC FPGA 120 follows. An important objective of the EFC FPGA is to act as an intermediary between the transport interfaces and the SDRAM array cards where the system data is stored. The transport interfaces, also called the front-end, include two Fibre Channel chips, i.e. FCC ICs 110, 111. The SDRAM array cards 150, which form the back-end, consist of banks of SDRAM memory chips. There can be up to sixteen cards of 526 MB, 1 GB, 2 GB, or 4 GB of storage each. The front-end chips share an 18 bit (16 data+2 parity) bi-directional bus which operates off of an 80 MHz synchronous clock. The SDRAM array cards share a 72 bit (64 data+8 parity) bi-directional bus which references a 40 MHz synchronous clock. Therefore, the FPGA reconciles the differences between these two interfaces in terms of both bus width and clock frequency. In order to move data to or from the SDRAM array cards, the FPGA generates an address and several control signals. In addition, it performs error detection and correction on all data read from the SDRAM array cards. If an error is detected, a Write cycle is automatically performed to write the corrected data back to the SDRAM. The FPGA also generates periodic refresh cycles that are required by the SDRAM to maintain its stored data.

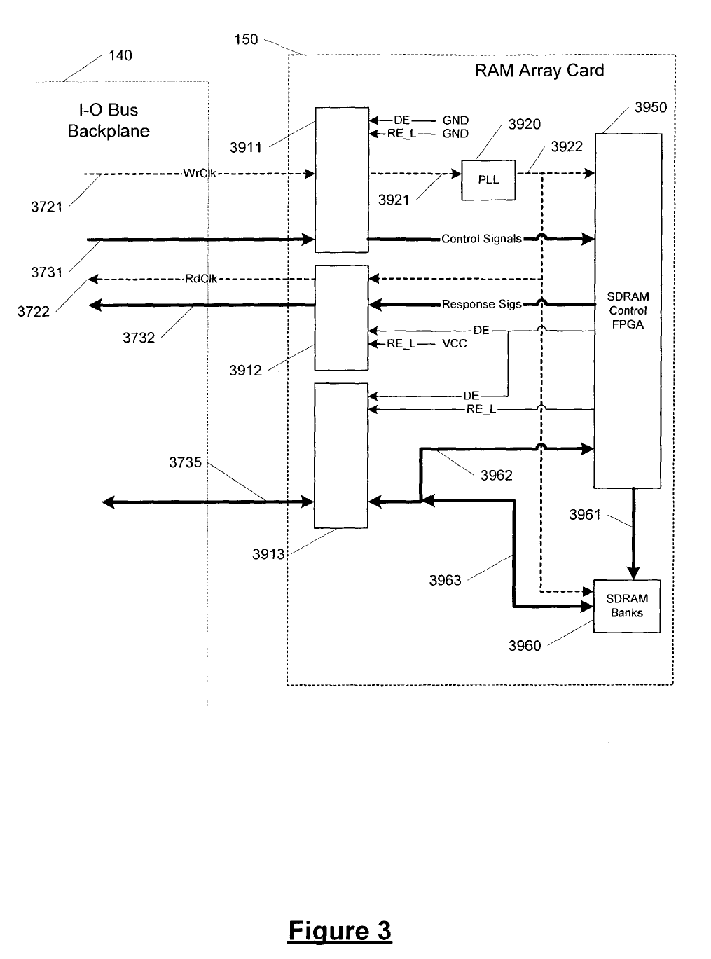

FIG. 3 shows a 150 SDRAM array card connected to a backplane I-O bus 140 in block diagram form. It is well known in the art that SDRAM memories 3960 provide a superior tradeoff between cost, high data rates, low latency and high capacity as compared with previously developed memory technologies. Indeed SDRAMs are known to perform best where the nature of the application is such that data is extensively accessed in bursts of consecutive addresses which is ostensibly an excellent fit to the subject file storage device applications which may typically involve transferring large blocks of consecutively addressed data.

Consequently, in the pursuit of highest performance embodiments of the invention, needs may arise for (a) using lots of memory arrays, essentially in parallel and (b) running the SDRAM at a high clock speed. However, this gives rise various implementation challenges as follows. Multiple SDRAM arrays may involve various long or unequal physical transmission distances to the multiple SDRAM arrays. This can make it difficult or impossible to arrange the SDRAM data clocks (Read and Write) with small margins for propagation time. Moreover, running the SDRAMs at a faster speed than the maximum corresponding available speed in the front-end circuitry potentially gives rise to overrun and/or underrun events. Thus, there is a need for carefully managing (pacing) the speed mismatch between front and back ends and without introducing excessive delays. Techniques of fast synchronous page pause/resume and multiple variable clock domains and cost effective implementations of each may be used as disclosed below.

Still referring to FIG. 3, three balun (balanced/unbalanced) line driver circuits 3911, 3912, 3913 are used to drive signals to and from backplane 140 which carries differential balanced signals on conductor pairs. Balanced (“2-wire”)/Unbalanced (single “wire”) drivers are well known in the art. Backplane 140 may be a bus arrangement and multiple SDRAM array cards 150 may be connected electrically in parallel. Balun 3911 is fixed in unidirectional operation, receiving signals from backplane 140.

Balun 3913 is bi-directional capable (only one direction at a time) and may be turned around in operation under the control of SDRAM Controller FPGA 3950 using control signals DE (drive-enable) and RE_L (receive-enable, active low). Balun 3912 is also unidirectional in operation under the control of SDRAM Controller FPGA 3950. Baluns 3913 and 3912 may be enabled to drive (3913 or 3912) or receive (3913 only) on, at most, one SDRAM array card 150. When not enabled, baluns 3913 and 3912 are “tri-stated” (present a high impedance load on the backplane) under FPGA 3950 control.

SDRAM Controller FPGA 3950 generates control signal and strobes 3961 for banks of SDRAMs 3960, including in one embodiment at least such chip dependent signals as bank addresses, Row/Column multiplexed addresses, commands (WE#, RAS#, CAS#, CS#), and Sleep CLE. Such exemplary signals are well known requirements for common types of SDRAM.

Thus, banks of SDRAM chips 3960 may for example consist of 18 chips in parallel, each chip being 4 bits wide. Unbalanced 72 bit Data highway 3963 may connect to 72 bit Address/Data highway 3963 to and from bi-directional balun (balanced/unbalanced) line driver 3913. Balun line driver 3913 may also drive the address portion 3962 of the highway, which address portion may typically be the least significant 32 conductors of the Address/Data highway. The address portion 3962 may be received by FPGA 3950. Balun 3913 may alternately receive or drive the corresponding 72 conductor pairs of the multiplexed bus balanced conductors 3735.

In operation, FPGA 3950 very rapidly decodes Address portion 3962 and if the address falls within the range of addresses served by the SDRAM array card 150 then the card is enabled to operate to serve a data transfer to and/or from SDRAM banks 3960. SDRAM array cards 150 are arranged to serve mutually exclusive addresses so that at most one SDRAM array cards 150 is enabled at any instant.

In an exemplary embodiment of the invention, output control signals 3731 are a set of circuits received by balun 3911. These circuits 3731 are active low when converted to equivalent unbalanced circuits and are as follows. ALE_L, MemWr_L, MemRd_L, WrDV_L, Pause_L, RFRQ_L. The usage of these signals may be determined by reference to table 1, below. Also received by balun 3911 is WrClk 3721, the write clock signal. The usage of the various signal is explained below.

In the same exemplary embodiment of the invention, input control signals 3732 are similarly RdDV_L, WrAck_L, CardPres_L and CardSize (which is an unbalanced, two-circuit, two bit wide signal). Also inbound may be RdClk 3722, the read clock signal as depicted.

TABLE 1
Glossary of Backplane signals

| | |
|---|---|
| WrClk | clock for the write data transfers, also the global |
| | array card clock |
| A/D(31:0) | address/data bus; addresses are multiplexed onto the |
| | lower 32 bits of the data bus |
| DB(71:32) | data bus |
| ALE_L | address latch enable, active low; a valid address is |
| | on the backplane |
| MemWr_L | memory write signal, active low; the transfer will be |
| | in the write direction |
| WrACK_L | write acknowledge signal, active low; acknowledgment |
| | of a write transfer |
| WrDV_L | write data valid signal, active low; write data on the |
| | backplane is valid |
| MemRd_L | memory read signal, active low; the transfer will be |
| | in the read direction |
| Pause_L | pause signal, active low; used to pause read transfers |
| RdClk | clock for read transfers |
| RdDV_L | read data valid signal, active low; read data on the |
| | backplane is valid |
| RFRQ_L | refresh request signal, active low; requests a |
| | refresh cycle to occur |
| CardPres_L | card present signal, active low; signifies that a card is |
| | present at an address |
| CardSize(1:0) | card size set; encodes the memory size storage capacity |
| | of the array card |

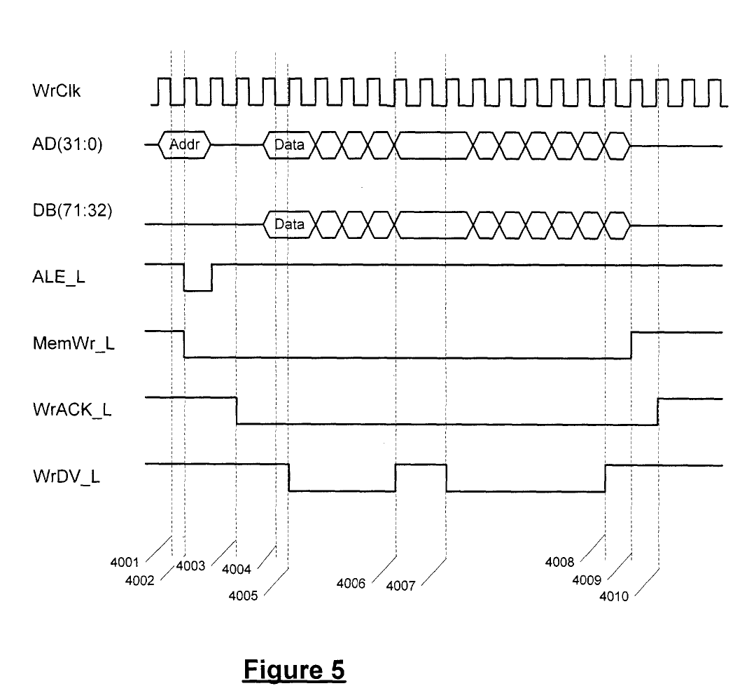

During a Write data transfer from a controller card 100 (shown in FIG. 1 but not shown in FIG. 3) via a backplane 140 to a SDRAM array card 150, incipient data underrun may occur. The controller card 100 manages incipient data underrun using the WrDV_L signal as described below and in connection with FIG. 5.

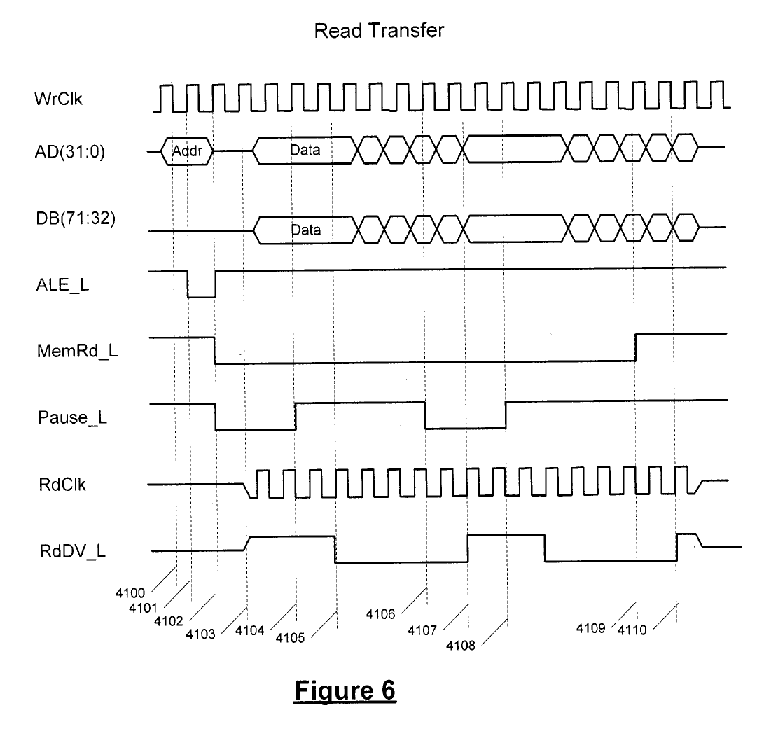

During a Read data transfer from a SDRAM array card 150 to a controller card 100, incipient data overrun may occur. The controller card 100 manages incipient data overrun using the Pause_L signal as described below and in connection with FIG. 6.

The balance WrClk signal 3721 is distributed by the backplane 140 to all of the connected SDRAM array cards 150. Balun 3911 receives the balanced WrClk signal and generates an unbalanced clock signal 3921 which is fed into a PLL (Phase locked loop circuit) 3920. PLLs are well known in the art. PLL 3920 produces a clean clock signal 3922 which is used to clock FPGA 3950 and SDRAM Banks 3960. The clean clock signal 3922 is also fed to balun 3912. During a Read data transfer or a Write data transfer the FPGA and SDRAM bank 3960 are clocked by the PLL 3920 output clean clock signal 3922. During a Read data transfer balun 3912 is enabled, under FPGA control, to drive RdClk 3722 onto backplane 140. However balun 3912 is enabled only on the particular SDRAM array card 150 that has been addressed for the transfer. In general only one SDRAM array 150 drives the inbound circuits on backplane 150 and all other cards tri-state the respective circuits to thus avoid circuit-driving conflicts, and especially to ensure that no more than one SDRAM array 150 is driving a clock onto RdClk circuit 3722.

Referring back to FIG. 2, multiple clock domains (not shown) may be provided on EFC FPGA 120. In particular, within EFC FPGA 120 a locally generated clock (as may be generated for example using a quartz crystal controlled oscillator, not shown) is used to strobe outgoing Write data, but a different clock is used for incoming Read data. The clock used for Read data is, of course, the RdClk from the enabled SDRAM array card 150 as described above in connection with FIG. 3. Precisely because the RdClk travels a physical route that parallels the data paths taken by the Read data originating in the SDRAM array cards there is no significant risk of loss of phase margin. This is particularly important since the various SDRAM array cards may be variously positioned and have various propagation times. Thus and advantageously, the design need not assume a worst case clock differential due to temporally different propagation lengths. Temporally different propagation lengths arise out of enabling different chips at different times. In particular, the large memory arrays used have many chips and they cannot all be placed in optimal proximity. In particular, the incoming data decoder of the EDC block 1530 derives its read clock from the memory array. According to whichever block of memory is selected the clock may have different timings, however the timings remain consistent for a relatively long period as a memory block is extensively accessed. A Read clock phase locked to both memory and decoder is thus provided with good economy and without creating many expensive and potentially costly and unreliable clock sources since each memory block derives and outputs a Read clock from the supplied write clock. The Write clock is broadcast to all SDRAM blocks and multiple read clocks derived therefrom in a point to multipoint arrangement. The cost and speed benefits by reduced timing margins are great.

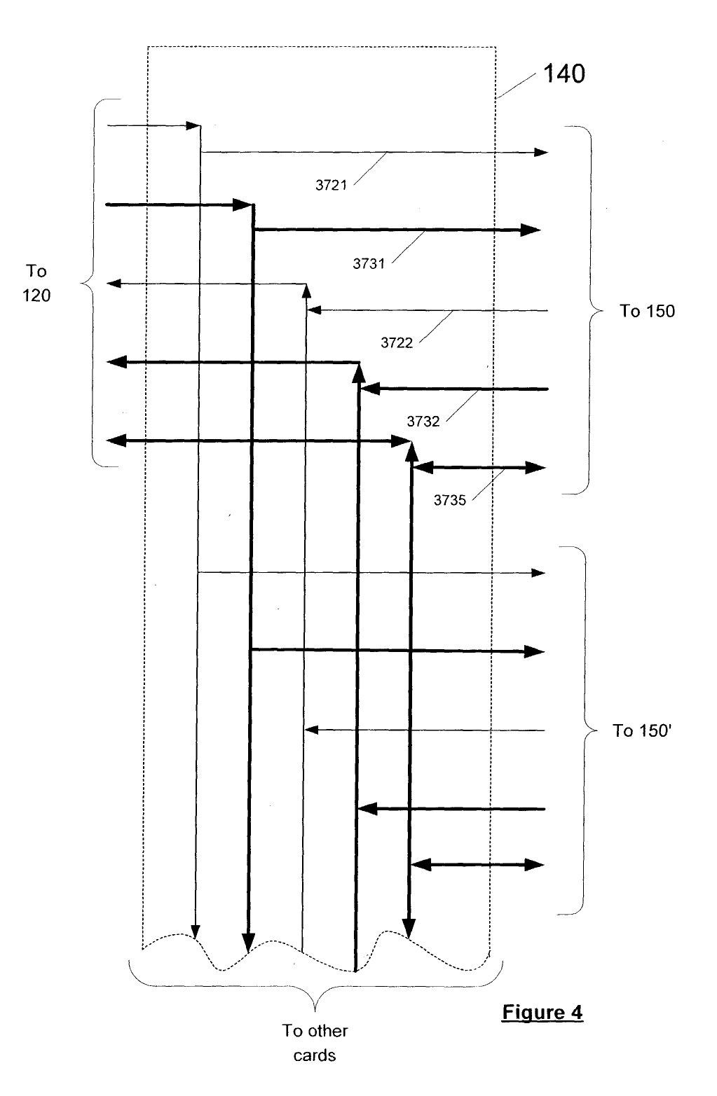

FIG. 4 depicts I-O bus backplane 140 with connections to EFC FPGA 120 and multiple SDRAM array cards 150, 150′ and possibly others (not shown in FIG. 4). Backplane 140 provides balanced circuits 3721, 3731, 3722, 3732 and 3735. Backplane 140 also provides, but not shown in the drawing, mechanical connectors to provide for connection of a configurable number of SDRAM array cards 150, 150′, etc.

FIG. 5 is a timing diagram that shows timings associated with Write transfer flow control to show how control of incipient data underrun may be resolved.

At instant 4001, the EFC FPGA (ref. 120 in FIG. 2) drives a starting Block Address onto the Address/Data lines.

At instant 4002, the EFC FPGA asserts the Address Latch Enable signal to notify the SDRAM array cards that a valid Block Address is on the backplane.

Also at instant 4002 the EFC FPGA asserts the Memory Write signal to indicate that the transfer will be in the Write direction.

At instant 4003 and after determining that the Block Address is within its range, the selected SDRAM array card asserts the Write Acknowledge signal to indicate that it is ready to receive data.

At time 4004 onwards, the EFC FPGA then transfers data over the Address/Data and Databus lines. A new 72-bits of data is sent on every rising edge of the Write Clock.

At instant 4005 onwards, the EFC FPGA asserts the Write Data Valid signal. The data on the backplane is valid for every rising edge of Write Clock that Write Data Valid is asserted.

At instant 4006, the write transfer needing to pause temporarily to avoid impending underrun, the EFC FPGA de-asserts Write Data Valid and holds the last word of data on the backplane.

At instant 4007, to continue the transfer, the EFC FPGA re-asserts Write Data Valid.

At instant 4008, the last word of data is transferred.

At instant 4009, the transfer is complete, so the EFC FPGA de-asserts the Memory Write signal.

At instant 4010, the SDRAM array card de-asserts Write Acknowledge in response to the de-assertion of the Memory Write signal.

FIG. 6 is a timing diagram that shows timings associated with Read transfer flow control to show how control of incipient data overrun may be resolved.

At instant 4100, the EFC FPGA drives the starting Block Address on the Address/Data lines.

At instant 4101, the EFC FPGA asserts the Address Latch Enable signal to notify the SDRAM array cards that a valid Block Address is on the backplane.

Soon thereafter, at instant 4102, the EFC FPGA asserts the Memory Read signal to indicate that the transfer will be in the Read direction. It simultaneously asserts the Pause signal to hold off the SDRAM array card while it prepares to receive the read data.

At instant 4103, after determining that the Block Address is within its range, the selected SDRAM array card begins driving the Read Clock signal and the Address/Data and Databus lines.

At instant 4104, the EFC FPGA is ready to receive data, so it de-asserts Pause.

At instant 4105, the SDRAM array card begins transferring data and asserts the Read Data Valid in response to the de-assertion of Pause. A new 72-bits of data is valid on the Data Bus (DB71:32 and AD31:0) on each and every rising edge of Read Clock so long as Read Data Valid remains asserted.

At instant 4106, the Read transfer needs to pause temporarily (typically in order to prevent Read underrun), so the EFC FPGA re-asserts Pause.

At instant 4107, the SDRAM array card responds to the Pause signal by de-asserting Read Data Valid (RdDV_L) and holding the last word of data unchanged on the Data Bus.

At instant 4108, the EFC FPGA de-asserts Pause to signal availability of buffer space and hence an end to the need for Pause.

At instant 4109, the transfer is complete, so the EFC FPGA de-asserts the Memory Read signal.

At instant 4110, the SDRAM array card de-asserts Read Data Valid, and stops driving Address/Data, Databus, and Read Clock in response to the de-assertion of the Memory Read signal. This completes a Read data transfer procedure.

The flow of data through the controller 100 is such that there is minimal intermediate storage. This minimizes repropagation delays. When a data transfer begins, for example, in the Read direction, a bank in the SDRAM array card is opened. Data then flows from the SDRAM through the controller 100 with, at most, minor hesitations. Differences in transfer rates between the front-end and back-end interfaces may be handled by brief storage in the FIFO and by throttling. To throttle, or slow down a transfer, the SDRAM array cards may be paused such that they will temporarily stop sending data. When a FIFO has emptied, the SDRAM array cards may resume transferring data without requiring a new address phase. Infrequently, restart and re-addressing may be necessary, such as at page boundaries.

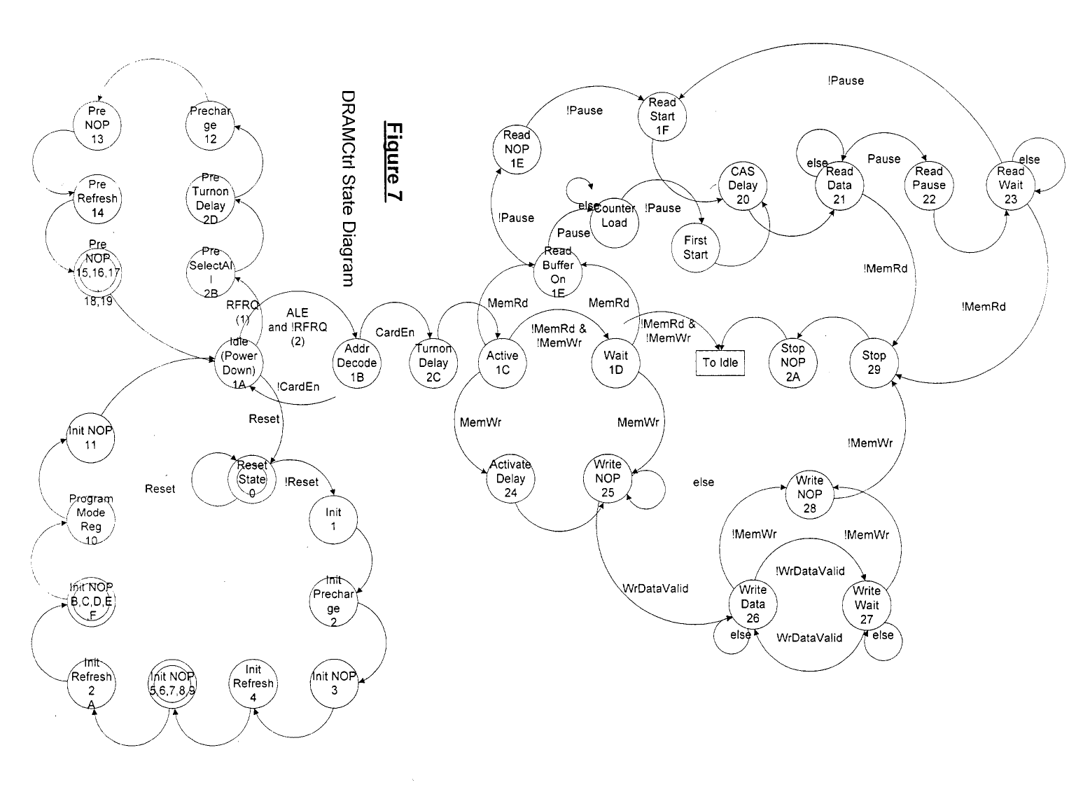

FIG. 7 shows a state machine diagram for a FSM embodied within the SDRAM Control FPGA 3950 (FIG. 3) on an SDRAM array card 150 (FIG. 3) according to an embodiment of the invention.

TABLE 2
SDRAM Control State Diagram Glossary

| | |
|---|---|
| Init | Initialization mode |
| ALE | Address latch enable signal |
| RFRQ | Refresh request signal |
| Addr Decode | Decode the address |
| CardEn | Card enable signal |
| MemWr | Memory write signal from EDC state machine |
| MemRd | Memory read signal from the EDC state machine |
| WrDataValid | Write data valid signal |
| CAS Delay | Column address strobe delay |
| Burst Term | Burst terminate |

This state machine resides in the FPGA 3950 (FIG. 3) on the SDRAM array cards. It responds to commands from the EFC FPGA 120 and generates all of the signals necessary for controlling the SDRAM chips. Any time an ALE is asserted on the backplane, the FSM of each of the array cards transitions to Addr Decode to decode the address. The card being addressed moves to the Active state while the others return to Idle.

In the Write direction, the FSM transitions to the Write Data state (FIG. 7, reference 26) when it receives the WrDataValid signal from the controller card 100. In this state, data is being written to the SDRAM chips. Should the WrDataValid signal be de-asserted, it will transition to Write Wait to pause the transfer. When the MemWr signal is de-asserted, the FSM returns to Idle.

In the Read direction, the FSM must enable the card's output buffers so it can drive the backplane. Then it performs the necessary commands to read data from the SDRAMs. In the Read Data state, data is being read from the SDRAMs and simultaneously being placed on the backplane. Should the Pause signal be asserted, the FSM will transition to Read Wait to pause the transfer. When it is de-asserted, it repeats the above process to begin reading again. When the MemRd signal is de-asserted, the FSM returns to Idle.

When using typical SDRAM memory chips, a “Read Pause” may be accomplished at the chip level by the FPGA 3950 issuing a Burst Terminate command to initiate the pause and later issuing a Read Command to resume the burst. This can be done quickly and without a performance hit because the SDRAM does not need to be re-addressed or pre-charged to resume a block transfer from where it left off. This can be done because the EFC FPGA 120 is able, in effect, to guarantee a maximum pause time and not to hold the SDRAM control FPGA 3950 off for an arbitrarily long period. Arbitrarily long pauses could give rise to other issues such as a need for refresh which could make such a relatively simple pause/resume technique impracticable.

A burst terminate issued mid-block may be used in a similar manner for Write transfers that underrun the available data stream. The EFC FPGA 120 cannot stop the transfer instantly and so it may be necessary for the EFC FPGA 120 to, in effect, give timely warning of incipient overrun or underrun rather than signaling after the event.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims. For example, present and future memory technologies other than SDRAM may have similar characteristics sufficient to be useful for embodying the invention.

What is claimed is:

1. A memory storage device comprising:
a first controller operable to generate a write clock signal, a plurality of address signals and a plurality of write data signals, the first controller further operable to receive a plurality of read data signals and a read clock signal;
a bus connected to the first controller the bus operable to carry the write clock signal, the plurality of address signals, the pluralities of data signals, and the read clock signal; and
a plurality of memory arrays, each memory array connected to the bus and comprising:
a plurality of semiconductor memories operable to receive the plurality of write data signals and to generate the plurality of read data signals;
a second controller operable to receive the plurality of address signals and to control the semiconductor memories; and
a clock circuit operable to receive the write clock signal and to generate the read clock signal in response to a clock control signal generated by the second controller.

2. The device of claim 1
wherein the first controller is operable to receive read data conveyed on the read data signals synchronously with the read clock signal.

3. The device of claim 1
wherein the clock circuit comprises a phase locked loop.

4. The device of claim 1
wherein the pluralities of signals carried by the bus are conveyed on balanced circuits.

5. A storage device comprising:
a controller; and
a plurality of arrays of SDRAMs;
wherein:
in response to a first signal received from the controller,
a first array of SDRAMs selected from the plurality of arrays of SDRAMs is enabled to receive a write clock from the controller and to record a first plurality of data to the first array of SDRAMs in synchronism with the write clock; and
in response to a second signal received the controller,
a second array of SDRAMs selected from the plurality of arrays of SDRAMs is enabled to generate a read clock, to read a second plurality of data from the second array of SDRAMs and to transmit the read clock and the second plurality of data to the controller in synchronism with the read clock.

6. The device of claim 5 wherein:
the controller comprises a phase locked loop circuit operable to phase lock the read clock to the write clock.

7. A memory storage device comprising:
a first controller operable to generate, a plurality of address signals, a plurality of output control signals and a pause signal;
a bus connected to the first controller, the bus operable to carry the plurality of address signals, the plurality of output control signals and the pause signal; and
a plurality of memory arrays, each memory array connected to the bus and comprising:
a plurality of synchronous semiconductor memories operable to receive the plurality of address signals and further operable to perform an exchange of a plurality of data in burst mode with the first controller via the bus; and
a second controller operable to receive the plurality of address signals, the plurality of output control signals and the pause signal and to control the semiconductor memories;
wherein the second controller is operable to provide a plurality of strobe signals to the semiconductor memories in response to the output control signals and;
wherein the second controller is further operable to initiate the exchange in response to the output control signals and;
wherein the second controller is further operable to terminate a first burst within the exchange in response to the pause signal and;
wherein the second controller is further operable to initiate a second burst within the exchange prior to the semiconductor memories receiving any further address signals.

8. A method for storing memory comprising:
providing a first controller operable to generate a write clock signal, a plurality of address signals and a plurality of write data signals, the first controller further operable to receive a plurality of read data signals and a read clock signal;
providing a bus connected to the first controller, the bus operable to carry the write clock signal, the plurality of address signals, the pluralities of data signals, and the read clock signal; and
providing a plurality of memory arrays, each memory array connected to the bus and comprising:
a plurality of semiconductor memories operable to receive the plurality of write data signals and to generate the plurality of read data signals;
a second controller operable to receive the plurality of address signals and to control the semiconductor memories; and
providing a clock circuit operable to receive the write clock signal and to generate the read clock signal in response to a clock control signal generated by the second controller.

9. A method for storing memory comprising:
providing a first controller operable to generate, a plurality of address signals, a plurality of output control signals and a pause signal;
providing a bus connected to the first controller, the bus operable to carry the plurality of address signals, the plurality of output control signals and the pause signal; and
providing a plurality of memory arrays, each memory array connected to the bus and comprising:
a plurality of synchronous semiconductor memories operable to receive the plurality of address signals and further operable to perform an exchange of a plurality of data in burst mode with the first controller via the bus; and
a second controller operable to receive the plurality of address signals, the plurality of output control signals and the pause signal and to control the semiconductor memories;
wherein the second controller is operable to provide a plurality of strobe signals to the semiconductor memories in response to the output control signals and;
wherein the second controller is further operable to initiate the exchange in response to the output control signals and;
wherein the second controller is further operable to terminate a first burst within the exchange in response to the pause signal and;
wherein the second controller is further operable to initiate a second burst within the exchange prior to the semiconductor memories receiving any further address signals.
